(19) United States
(12) Patent Application Publication
(10) Pub. No.: US 2021/0162686 A1
(43) Pub. Date: Jun. 3, 2021

(54) SYSTEMS FOR AND METHODS OF FORMING STRUCTURAL COMPONENTS

(71) Applicant: OCV Intellectual Capital, LLC, Toledo, OH (US)

(72) Inventor: Tom Wassenberg, Lünne (DE)

(21) Appl. No.: 17/054,188

(22) PCT Filed: May 24, 2019
(86) PCT No.: PCT/US2019/033871

§ 371 Date: Nov. 10, 2020

Related U.S. Application Data
(60) Provisional application No. 62/681,875, filed on Jun. 7, 2018.

(51) Int. Cl. B29C 70/54; B29C 70/30; B29C 31/10

(52) U.S. Cl. CPC B29C 70/543; B29C 31/10; B29C 70/30

(57) ABSTRACT

Systems (300) for and methods of forming structural components from a source, such as one or more rolls (302), of a fibrous material (e.g., fabric) are disclosed. The fibrous material (304) is made up of multiple layers (308, 310, 312), with at least one pair of adjacent layers having different lengths.

### CROSS REFERENCE TO RELATED APPLICATIONS

This application claims priority to and any benefit of U.S. Provisional Patent Application No. 62/681,875, filed Jun. 7, 2018, the entire content of which is incorporated herein by reference.

### FIELD

The general inventive concepts relate to fiber reinforced materials and, more particularly, to systems for and methods of using fiber reinforced materials to produce structural components.

### BACKGROUND

It is known to use fiber reinforced materials, such as fabrics, mats, veils, and the like to form structural components. For example, U.S. Pat. No. 8,226,866 discloses production of a laminate by a continuous process. The process involves pulling tows of fibers (e.g., glass fibers or carbon fibers) through a bath of resin, wherein the resin is then cured to form the laminate. Within the laminate, the fibers are arranged side by side and substantially parallel to one another. Such a laminate is often referred to as a unidirectional laminate. The laminate can have a thickness of 1 mm to several mm. The laminate can be formed to have almost any practical width. After production, the sheet-like laminate is wound up into rolls, each having a length of a couple hundred meters.

These laminates are useful for forming structural components. As noted in the '866 patent, these laminates can be stacked up or otherwise layered to form a spar cap of a blade of a wind energy turbine. In particular, several layers of cut pieces of the laminate are arranged on top of each other to form the structural component. The pieces are arranged within specific areas and regions of a mold. An infusion process introduces a curable matrix material (a resin) into the mold in order to penetrate the layers of the laminate. A vacuum can be applied to the mold during the infusion process to press the layers of cut pieces together and aid the resin in penetrating the layers.

A conventional system 100 for forming a structural component, in this case a spar cap of a wind turbine blade, will be described with reference to FIGS. 1-3. In the system 100, a machine 102 continuously produces a fiber reinforced material in the form of a woven fabric 104 having a predetermined width w. The fabric 104 includes or is otherwise reinforced with fibers (e.g., glass and/or carbon fibers) that extend substantially along a length of the fabric 104 (i.e., parallel to the arrow 106). As the fabric 104 exits the machine 102 and travels in a direction indicated by the arrow 106, the fabric 104 is wound at a roll area 108. A winder or other conveying means pulls the fabric 104 from the machine 102 to the roll area 108. Blades or other cutting means form slits 110 in the fabric 104 prior to the roll area 108. In this manner, discrete rolls 112 of the fabric 104 are formed. In the embodiment shown in FIG. 1, three slits 110 are made to form four rolls 112, with each roll 112 having an approximate width of w/4.

Once a predetermined quantity of the fabric 104 has been wound to the roll area 108, a cut 114 is made across the width w of the fabric 104, thereby separating the rolls 112 from the fabric 104 exiting the machine 102. The machine 102 may be stopped or otherwise paused during this cutting operation.

As shown in FIG. 2, once the rolls 112 are separated from the fabric 104, a number of the rolls 112 are placed on a pallet 120 or otherwise packaged together for storage and/or transit, prior to use thereof. In FIG. 2, eight rolls 112 rest on the pallet 120. A typical footprint of the pallet 120 is 45 inches (width) by 54 inches (length).

When it is time to form the spar cap, rolls 112 from one or more pallets 120 are moved into proximity to a mold 128 used to form the spar cap. As noted above, the spar cap is formed by layering, such as by hand laying, a number of cut pieces of the fabric 104 from the rolls 112. The number and placement of the cut pieces within the mold 128 define the properties (e.g., shape, thickness) of the spar cap.

As shown in FIG. 3, a first roll 130 of the fabric 104 is taken off the pallet 120 and cut into pieces of desired lengths to be placed in the mold 128. In particular, a first quantity of the fabric 104 is unrolled in the direction of arrow 132 and then cut to form a first piece 134 of length L₁ represented by the dashed line 1-1. Next, a second quantity of the fabric 104 is unrolled in the direction of arrow 132 and then cut to form a second piece 136 of length L2 represented by the dashed line 2-2. As lines 1-1 and 2-2 indicate, the length L₁ of the first piece 134 is greater than the length L₂ of the second piece 136. While some cut pieces may have the same length, many of the cut pieces will have different lengths. Each successive cut piece is positioned on or otherwise overlapped with the preceding cut pieces. Typically, many cut pieces (e.g., 50 or more) are required. This process is repeated until a desired thickness and shape is obtained within the mold 128. Finally, resin is introduced into the mold, such as by the aforementioned infusion process, and cured to form the spar cap.

Since many cut pieces of the fabric 104 are required to form the spar cap, the forming process can be time intensive. This required forming time has continued to increase as the size and complexity of spar caps and related components have increased. Accordingly, there is an unmet need for improved systems for and methods of using fiber reinforced materials to produce structural components from rolls of material provided on pallets.

### SUMMARY

It is proposed herein to provide improved systems for and methods of forming structural components from a fiber reinforced material (e.g., obtained from rolls of the material).

In an exemplary embodiment, a system for producing a structural component formed by molding a plurality of layers of a fiber reinforced material is disclosed. The system comprises a roll of the fiber reinforced material, wherein the roll includes a plurality of layers of the fiber reinforced material, wherein a first layer of the fiber reinforced material on the roll is adjacent to a second layer of the fiber reinforced material on the roll, wherein a length of the first layer differs from a length of the second layer to form an offset, and wherein the offset corresponds to the desired positioning of the first layer relative to the second layer in a mold. In some exemplary embodiments, the offset contributes to an intended profile of the structural component.

In some exemplary embodiments, the roll comprises 3 to 10 layers of the fiber reinforced material. In some exemplary embodiments, the roll comprises at least 4 layers of the fiber reinforced material.

In some exemplary embodiments, the first layer is fixed to the second layer on the roll. In some exemplary embodiments, the first layer is fixed to the second layer by an adhesive. In some exemplary embodiments, the first layer is fixed to the second layer by stitching. In some exemplary embodiments, the first layer is fixed to the second layer by at least one removable clip. In some exemplary embodiments, the first layer is fixed to the second layer by mechanical entanglement of fibers in the first layer and fibers in the second layer.

In some exemplary embodiments, the structural component is a wind turbine blade. In some exemplary embodiments, the structural component is a spar cap.

In some exemplary embodiments, the fiber reinforced material includes glass fibers. In some exemplary embodiments, the fiber reinforced material includes carbon fibers.

In some exemplary embodiments, the system further comprises a resin for introducing into the mold. The resin is operable to be cured or otherwise hardened to bind the layers of the fiber reinforced material in the mold together.

In an exemplary embodiment, a system for producing a structural component formed by molding a plurality of layers of a fiber reinforced material is disclosed. The system comprises a roll of the fiber reinforced material, wherein the roll includes a plurality of layers of the fiber reinforced material, wherein the roll includes indicia of where to cut the fiber reinforced material to form a first length of the fiber reinforced material and a second length of the fiber reinforced material, wherein a first layer of the fiber reinforced material in the first length is adjacent to a second layer of the fiber reinforced material in the first length, wherein a third layer of the fiber reinforced material in the second length is adjacent to a fourth layer of the fiber reinforced material in the second length, wherein a length of the first layer differs from a length of the second layer to form a first offset, wherein a length of the third layer differs from a length of the fourth layer to form a second offset, wherein the first offset corresponds to the desired positioning of the first layer relative to the second layer in a mold, and wherein the second offset corresponds to the desired positioning of the third layer relative to the fourth layer in the mold. In some exemplary embodiments, the first offset and/or the second offset contributes to an intended profile of the structural component.

In some exemplary embodiments, the length of the first layer differs from the length of the third layer. In some exemplary embodiments, the length of the second layer differs from the length of the fourth layer.

In some exemplary embodiments, the roll comprises 3 to 10 layers of the fiber reinforced material. In some exemplary embodiments, the roll comprises at least 4 layers of the fiber reinforced material.

In some exemplary embodiments, the first layer is fixed to the second layer on the roll. In some exemplary embodiments, the first layer is fixed to the second layer by an adhesive. In some exemplary embodiments, the first layer is fixed to the second layer by stitching. In some exemplary embodiments, the first layer is fixed to the second layer by at least one removable clip. In some exemplary embodiments, the first layer is fixed to the second layer by mechanical entanglement of fibers in the first layer and fibers in the second layer.

In some exemplary embodiments, the third layer is fixed to the fourth layer on the roll. In some exemplary embodiments, the third layer is fixed to the fourth layer by an adhesive. In some exemplary embodiments, the third layer is fixed to the fourth layer by stitching. In some exemplary embodiments, the third layer is fixed to the fourth layer by at least one removable clip. In some exemplary embodiments, the third layer is fixed to the fourth layer by mechanical entanglement of fibers in the third layer and fibers in the fourth layer.

In some exemplary embodiments, the structural component is a spar cap.

In some exemplary embodiments, the fiber reinforced material includes at least one of glass fibers and carbon fibers.

In some exemplary embodiments, the system further comprises a resin for introducing into the mold. The resin is operable to be cured or otherwise hardened to bind the layers of the fiber reinforced material in the mold together.

In an exemplary embodiment, a method of producing a structural component formed by molding a plurality of layers of a fiber reinforced material is disclosed. The method comprises: providing a roll of the fiber reinforced material, wherein the roll includes a plurality of layers of the fiber reinforced material; removing a first length of the fiber reinforced material from the roll, the first length including a first layer of the fiber reinforced material and a second layer of the fiber reinforced material, wherein the first layer is adjacent to the second layer, and wherein a length of the first layer differs from a length of the second layer to form a first offset; and positioning the first length of the fiber reinforced material in a mold so that the first offset is at a desired location, thereby simultaneously positioning the first layer and the second layer in the mold.

In some exemplary embodiments, the method further comprises introducing a resin into the mold; and curing the resin to form the structural component.

In some exemplary embodiments, the method further comprises: removing a second length of the fiber reinforced material from the roll, the second length including a third layer of the fiber reinforced material and a fourth layer of the fiber reinforced material, wherein the third layer is adjacent to the fourth layer, and wherein a length of the third layer differs from a length of the fourth layer to form a second offset; and positioning the second length of the fiber reinforced material in the mold so that the second offset is at a desired location, thereby simultaneously positioning the third layer and the fourth layer in the mold.

In some exemplary embodiments, the first length is adjacent to the second length in the mold.

In some exemplary embodiments, the length of the first layer differs from the length of the third layer.

In some exemplary embodiments, the length of the second layer differs from the length of the fourth layer.

In some exemplary embodiments, the roll comprises 3 to 10 layers of the fiber reinforced material. In some exemplary embodiments, the roll comprises at least 4 layers of the fiber reinforced material.

In some exemplary embodiments, the first layer is fixed to the second layer on the roll. In some exemplary embodiments, the first layer is fixed to the second layer by an adhesive. In some exemplary embodiments, the first layer is fixed to the second layer by stitching. In some exemplary embodiments, the first layer is fixed to the second layer by at least one removable clip. In some exemplary embodiments, the first layer is fixed to the second layer by mechanical entanglement of fibers in the first layer and fibers in the second layer.

In some exemplary embodiments, the third layer is fixed to the fourth layer on the roll. In some exemplary embodiments, the third layer is fixed to the fourth layer by an adhesive. In some exemplary embodiments, the third layer is fixed to the fourth layer by stitching. In some exemplary embodiments, the third layer is fixed to the fourth layer by at least one removable clip. In some exemplary embodiments, the third layer is fixed to the fourth layer by mechanical entanglement of fibers in the third layer and fibers in the fourth layer.

In some exemplary embodiments, the structural component is a spar cap.

In some exemplary embodiments, the fiber reinforced material includes at least one of glass fibers and carbon fibers.

In some exemplary embodiments, the structural component is formed from a plurality of rolls of the fiber reinforced material.

In an exemplary embodiment, a package of fiber reinforced material for producing a structural component is disclosed. The package of fiber reinforced material includes multiple layers, wherein at least one pair of adjacent layers in the package has different lengths. In this manner, the layers are positioned relative to one another in the package based on their intended positioning relative to one another in a mold for forming the structural component.

In an exemplary embodiment, a roll of fiber reinforced material for producing a structural component is disclosed. The roll of fiber reinforced material includes multiple layers, wherein at least one pair of adjacent layers on the roll has different lengths. In this manner, the layers are positioned relative to one another on the roll based on their intended positioning relative to one another in a mold for forming the structural component.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

The general inventive concepts, as well as embodiments and advantages thereof, are described below in greater detail, by way of example, with reference to the drawings in which:

FIG. 1 is a diagram of a conventional system for forming a woven fabric.

FIG. 2 is a diagram of rolls of the woven fabric produced by the system of FIG. 1.

FIG. 3 is a diagram showing use of the rolls of FIG. 2 during production of the spar cap.

FIGS. 4A and 4B illustrate a conventional technique for forming a spar cap from a roll of fiber reinforced material. FIG. 4A is a diagram showing separation of discrete pieces from the roll of fiber reinforced material. FIG. 4B is a diagram showing placement of the pieces of FIG. 4A into a mold for forming the spar cap.

FIGS. 5A, 5B, and 5C illustrate a technique for forming a spar cap from a roll of fiber reinforced material, according to an exemplary embodiment. FIG. 5A is a diagram showing separation of a fabric stack from the roll of fiber reinforced material. FIG. 5B is a detailed view of a section of the fabric stack of FIG. 5A. FIG. 5C is a diagram showing placement of the fabric stack of FIG. 5A into a mold for forming the spar cap.

FIG. 6 is a diagram showing production of a fabric stack, according to an exemplary embodiment.

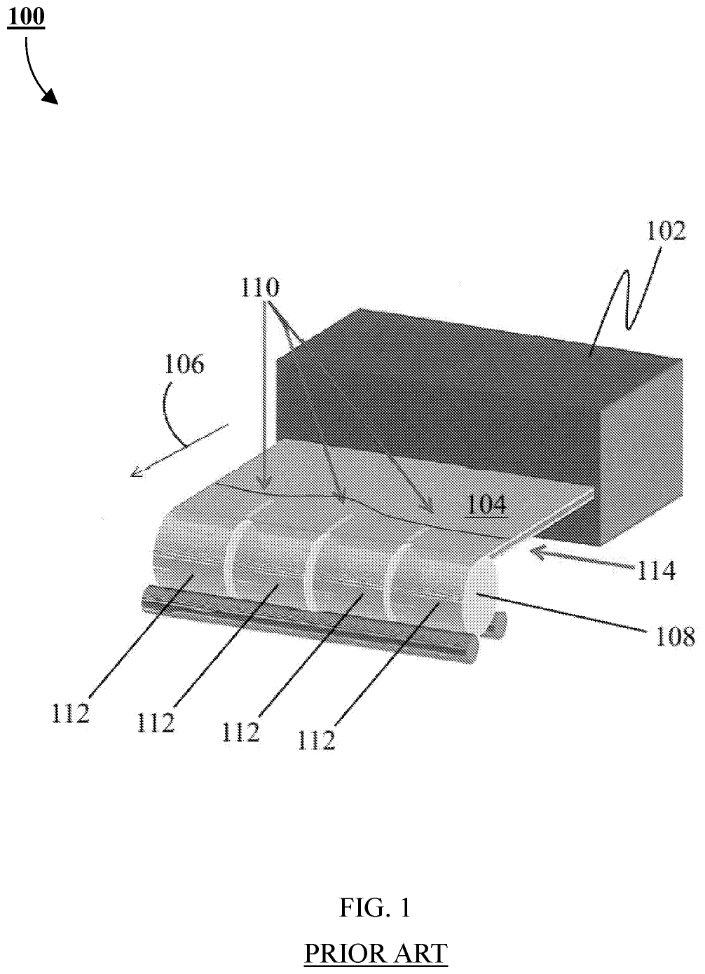

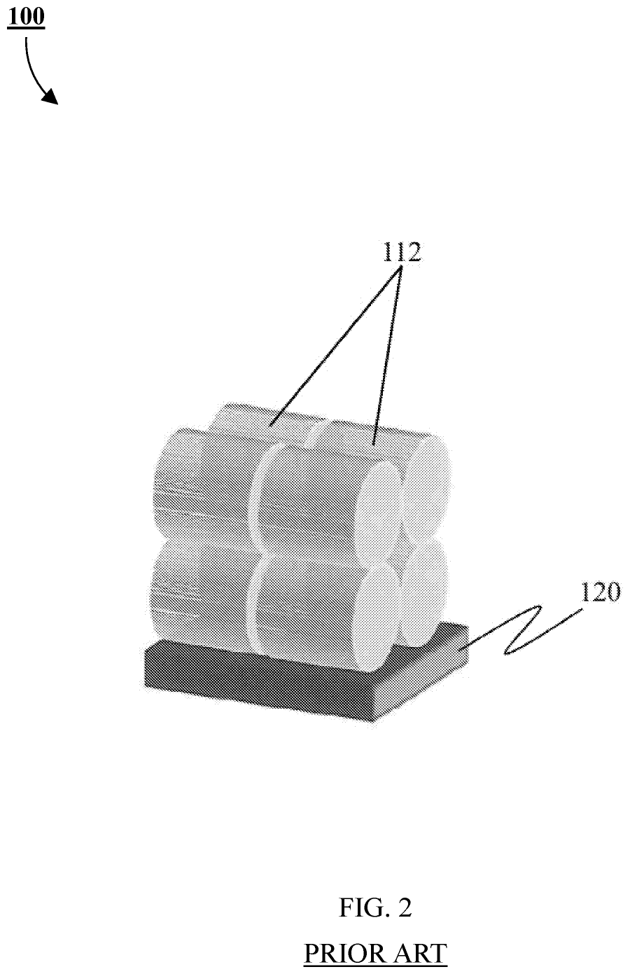

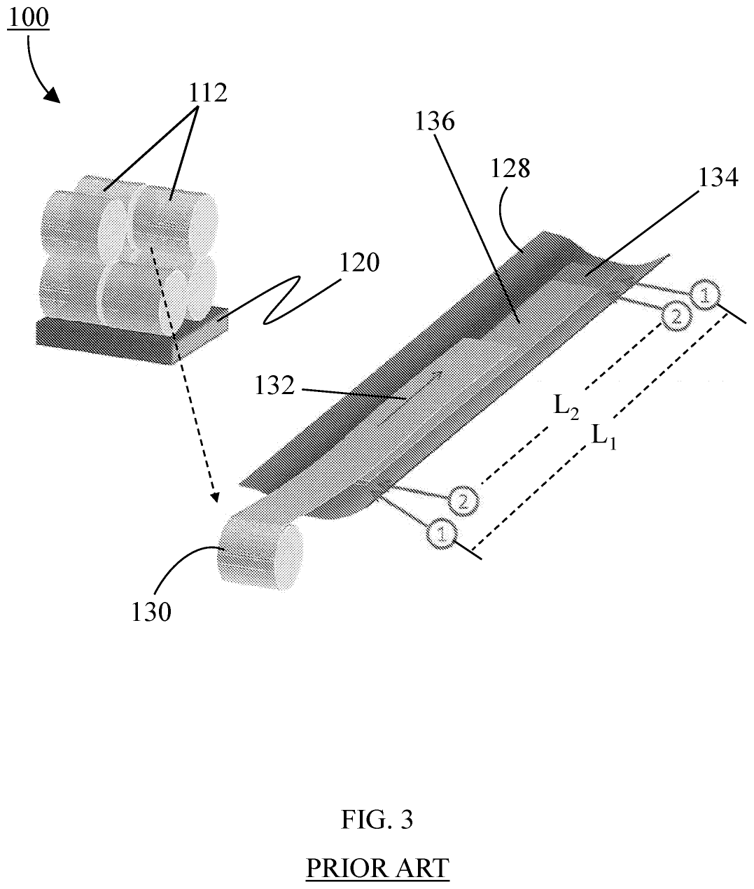

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts encompass systems for and methods of forming structural components from layers of a fiber reinforced material obtained from a source of the material. While the exemplary embodiments described herein disclose one or more rolls as the source of the fiber reinforced material, the general inventive concepts encompass other means of making, storing, and transporting the fiber reinforced material that do not involve rolling the fiber reinforced material into a roll. For example, the fiber reinforced material could be stacked on a pallet, folded in a box, etc.

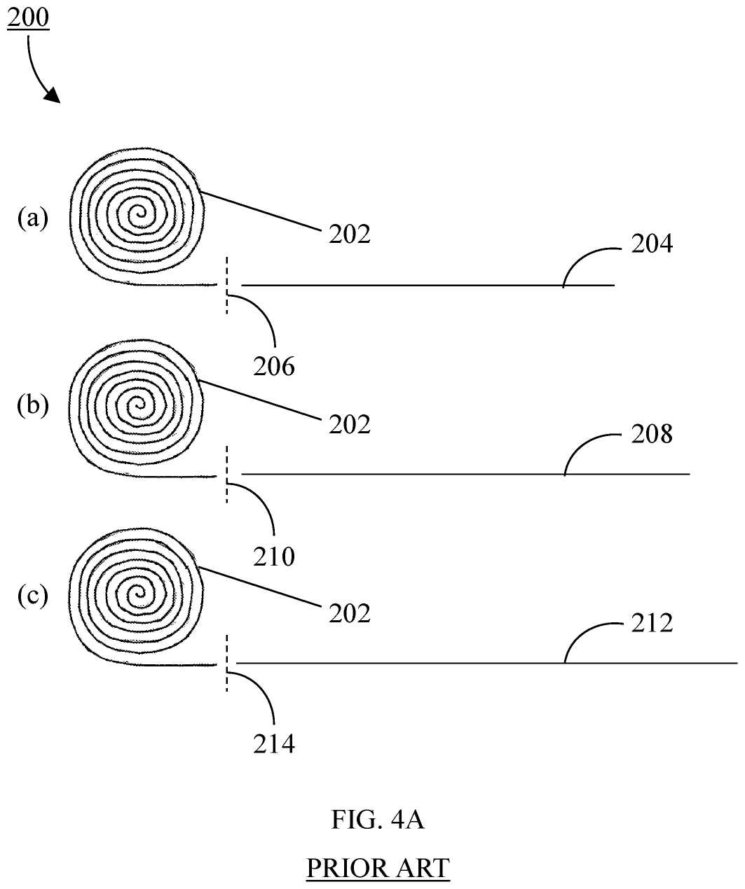

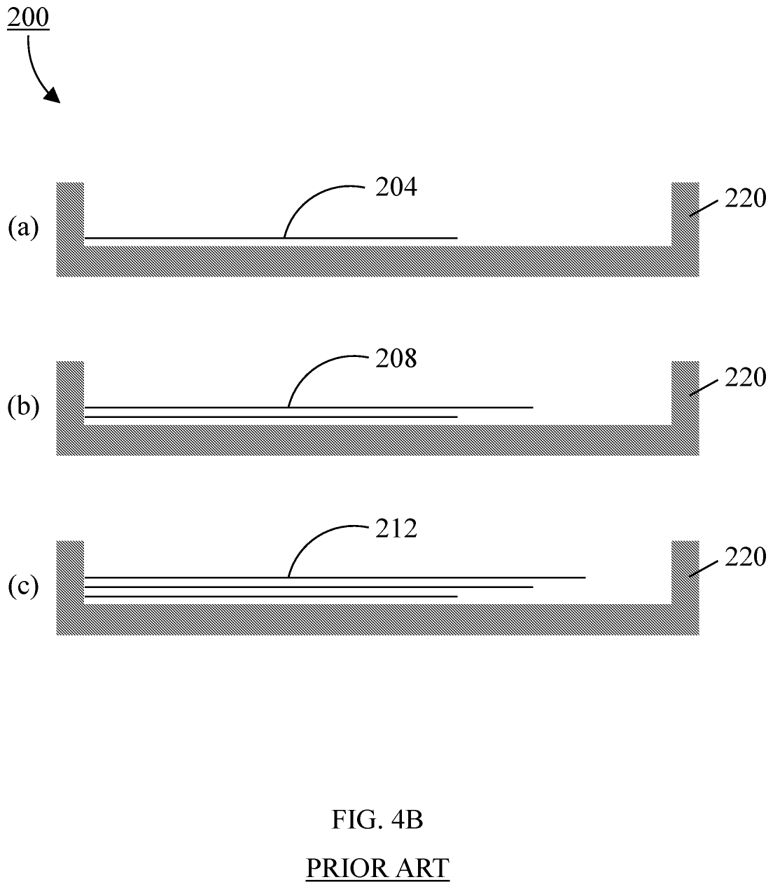

A conventional system 200 for forming a structural component (e.g., a spar cap) will be described with reference to FIGS. 4A and 4B. In the system 200, a roll 202 of a fiber reinforced material (e.g., the fabric 104) for forming the spar cap is provided.

A first portion 204 of the fiber reinforced material is unrolled and cut (indicated by dashed line 206) from the roll 202. Assume this processing takes a certain amount of time t₁.

The first portion 204 of the fiber reinforced material is then placed in a mold 220 and positioned according to a design specification for the spar cap. This processing takes a certain amount of time t₂.

Next, a second portion 208 of the fiber reinforced material is unrolled and cut (indicated by dashed line 210) from the roll 202. This processing takes a certain amount of time t₃.

The second portion 208 of the fiber reinforced material is then placed in the mold 220 and positioned relative to the first portion 204 of the fiber reinforced material according to the design specification for the spar cap. This processing takes a certain amount of time t₄.

Finally, a third portion 212 of the fiber reinforced material is unrolled and cut (indicated by dashed line 214) from the roll 202. This processing takes a certain amount of time t₅.

The third portion 212 of the fiber reinforced material is then placed in the mold 220 and positioned relative to the first portion 204 and the second portion 208 of the fiber reinforced material according to the design specification for the spar cap. This processing takes a certain amount of time t₆.

For simplicity's sake, assuming the spar cap is constructed from only the first, second, and third portions 204, 208, 212 of the fiber reinforced material, then the total processing time for forming the spar cap (without taking into account the time for introducing the resin into the mold and curing same) can be represented as: tₜₒₜₐₗ=t₁+t₂+t₃+t₄+t₅+t₆.

As can be seen, this total processing time (tₜₒₜₐₗ) for forming the spar cap will increase as the number of portions (i.e., layers) of the fiber reinforced material needed to be cut from the roll 202 and placed in the mold 220 increases.

As noted above, it is not uncommon for spar caps to require many (e.g., 50 or more) discrete pieces of the fiber reinforced material to be layered (e.g., hand laid) into the mold 220. Typically, many (if not all) of the pieces cut from the roll 202 will vary in length. The number and placement of the cut pieces within the mold 220 define the properties (e.g., shape, thickness) of the spar cap.

In the example shown in FIGS. 4A and 4B, the first portion 204 of the fiber reinforced material has a length L₁, the second portion 208 of the fiber reinforced material has a length L₂, and the third portion 212 of the fiber reinforced material has a length L₃, wherein L₃>L₂>L₁.

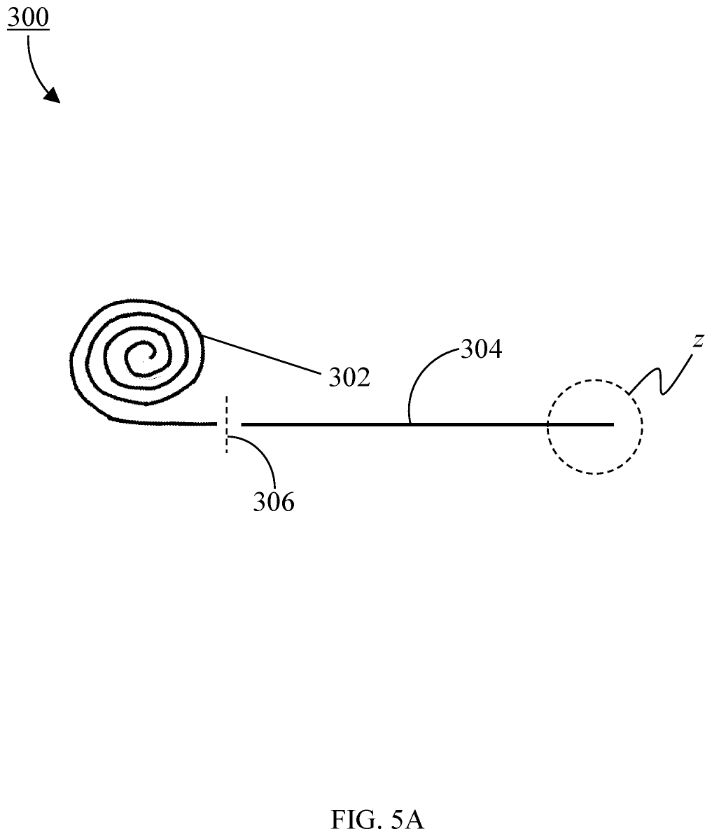

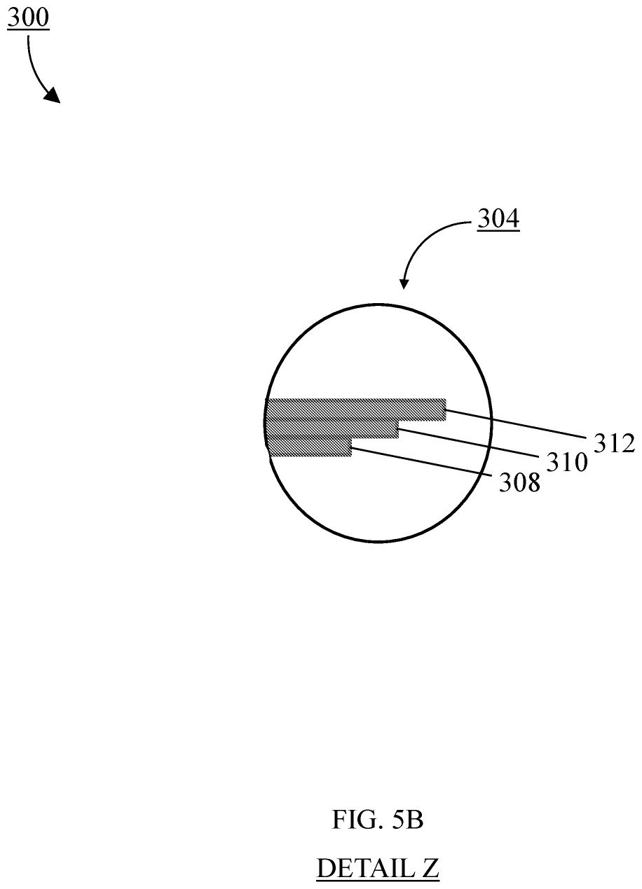

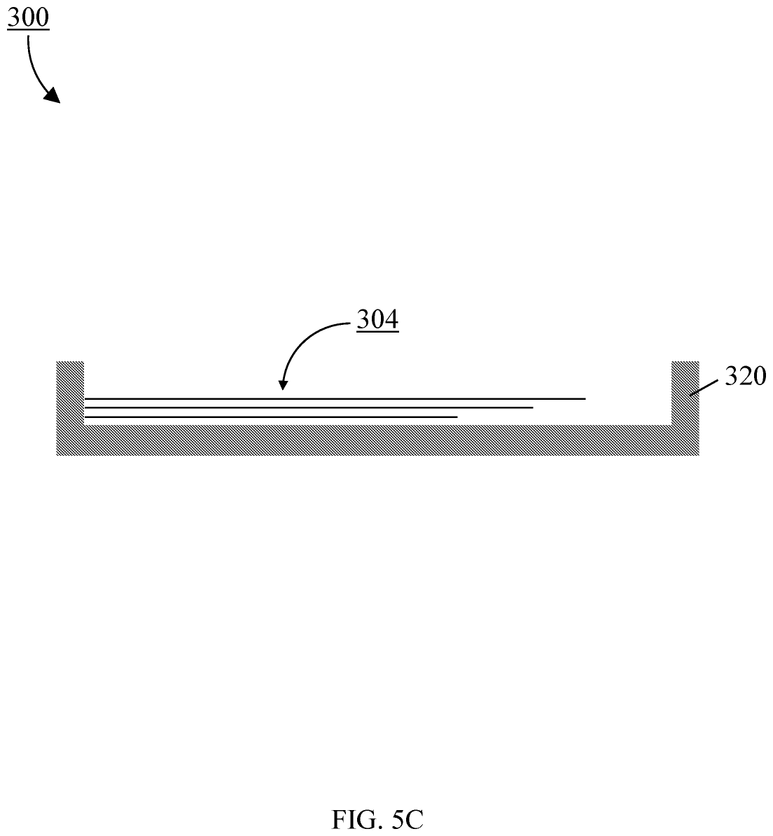

A system 300 for forming a structural component (e.g., a spar cap), according to an exemplary embodiment of the invention, will be described with reference to FIGS. 5A, 5B, and 5C. In the system 300, a roll 302 of a fiber reinforced material for forming the spar cap is provided. In this case, the fiber reinforced material is a fabric stack 304 comprising multiple discrete layers of the fiber reinforced material, wherein at least one pair of adjacent layers on the roll 302 has different lengths.

A portion of the fabric stack 304 is unrolled and cut (indicated by dashed line 306) from the roll 302. Assume this processing takes a certain amount of time t₇.

The portion of the fabric stack 304 is then placed in a mold 320 and positioned according to a design specification for the spar cap. This processing takes a certain amount of time t₈.

As shown in detail z of FIG. 5B, the portion of the fabric stack 304 includes three discrete layers, i.e., a first layer 308, a second layer 310, and a third layer 312. To facilitate a comparison, the first layer 308 of the fabric stack 304 has approximately the same make-up as the first portion 204 of the fiber reinforced material (including a length L₁), the second layer 310 of the fabric stack 304 has approximately the same make-up as the second portion 208 of the fiber reinforced material (including a length L₂), and the third layer 312 of the fabric stack 304 has approximately the same make-up as the third portion 212 of the fiber reinforced material (including a length L₃).

For simplicity's sake, assuming the spar cap is constructed from only the single portion of the fabric stack 304 unrolled and cut from the roll 302, then the total processing time for forming the spar cap (without taking into account the time for introducing the resin into the mold and curing same) can be represented as: tₜₒₜₐₗ=t₇+t₈. This is because the individual layers 308, 310, 312 are already positioned relative to one another on the roll 302 based on their intended positioning relative to one another in the mold 320 in accordance with the design specification for the spar cap.

Thus, treating the time t₇ to be approximately equal to the time t₁ and the time t₈ to be approximately equal to the time t₂, the total processing time of the system 300 is significantly reduced (e.g., by approximately t₃+t₄+t₅+t₆) compared to the total processing time of the conventional system 200. This processing time savings would be expected to further increase as the number of layers forming the fabric stack 304 on the roll 302 increases.

As noted above, the multiple layers (e.g., layers 308, 310, 312) in the fabric stack 304 are positioned relative to one another on the roll 302 based on their intended positioning relative to one another in the mold 320, according to a design specification for the structural component being molded.

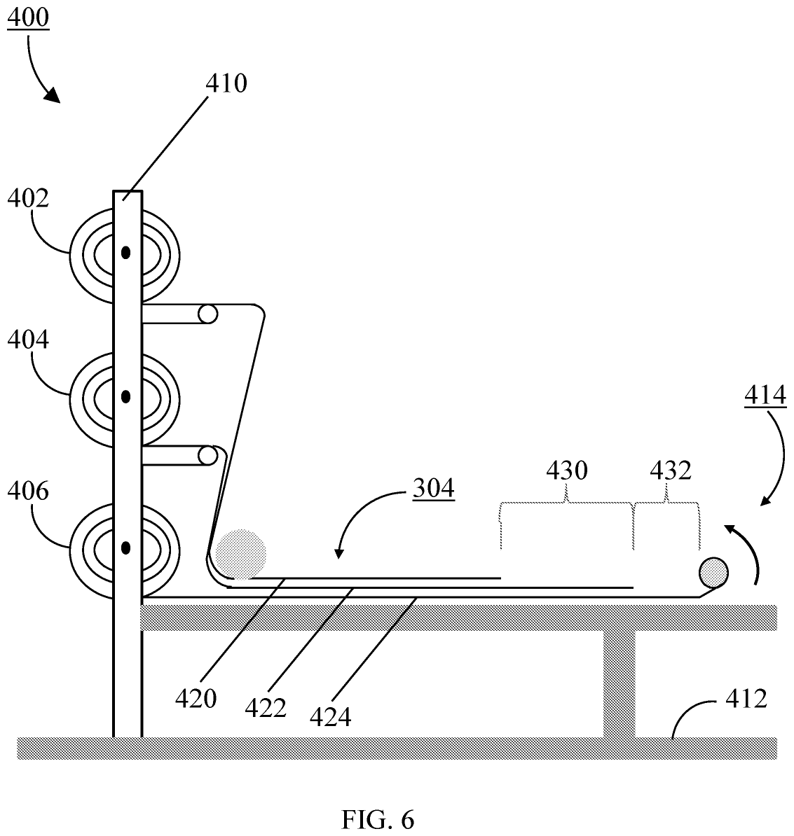

In some exemplary embodiments, the relative positioning of the layers in the fabric stack 304 is maintained simply by the rolling process (see FIG. 6).

In some exemplary embodiments, means for affixing the layers to one another could be used. Such affixing means might be used to prevent undesired movement of the layers relative to one another, such as during the rolling process or subsequent downstream handling of the fiber reinforced material (e.g., placement of the fabric stack 304 in the mold 320). The affixing means might also be effective in preventing wrinkles or like from forming in the fabric stack 304, as such wrinkles could introduce flaws in the molded structural component or otherwise require added production time to remove the wrinkles by hand.

Any means suitable for maintaining the relative positioning of each layer of fiber reinforced material in the fabric stack 304 could be used. In some exemplary embodiments, the affixing means is an adhesive. In some exemplary embodiments, the affixing means is a binder. In some exemplary embodiments, the affixing means involves mechanical entanglement (e.g., needling) of the layers. In some exemplary embodiments, the affixing means involves stitching the layers together. In some exemplary embodiments, the affixing means may be a temporary means of holding the layers in the fabric stack 304 together, such as removable clamps, clips, or the like.

A system 400 for producing the roll 302 of the fabric stack 304, according to an exemplary embodiment, is shown in FIG. 6.

Since the fabric stack 304 is made up of the first layer 308, the second layer 310, and the third layer 312 of the fiber reinforced material, the system 400 utilizes a first supply roll 402, a second supply roll 404, and a third supply roll 406 of the fiber reinforced material. A rack 410 or other structure for holding the supply rolls 402, 404, 406 is mounted on a frame 412 or other support structure (e.g., floor).

The fiber reinforced material is simultaneously unrolled from the supply rolls 402, 404, 406 to form the fabric stack 304. In particular, a first portion of the fabric stack 304 includes a first layer 420 of the fiber reinforced material having the length L₁, a second layer 422 of the fiber reinforced material having the length L₂, and a third layer 424 of the fiber reinforced material having the length L₃, which are fed to a winder 414 that winds the layers 420, 422, 424 into the roll 302. As noted above, L₃>L₂>L₁. In other words, the first layer 420 is offset from the second layer 422 by a length 430, while the second layer 422 is offset from the third layer 424 by a length 432, during winding of the layers 420, 422, 424 by the winder 414. These offset lengths can be repeated and/or varied for other portions of the fabric stack 304 on the roll 302.

By using a fabric stack (e.g., the fabric stack 304), as described herein, a spar cap or other molded structural component can generally be formed more quickly and in a less labor-intensive manner (providing a cost benefit). For example, a spar cap can be formed by layering, such as by hand laying, one or more portions of the fabric stack into a mold. The number of layers in each portion of the fabric stack and the relative offset lengths between the layers will correspond to the positioning of the individual layers of fiber reinforced material in the mold, thereby defining the properties (e.g., shape, thickness) of the spar cap.

It will be appreciated that the scope of the general inventive concepts is not intended to be limited to the particular exemplary embodiments shown and described herein. From the disclosure given, those skilled in the art will not only understand the general inventive concepts and their attendant advantages, but will also find apparent various changes and modifications to the systems and methods disclosed. For example, while various exemplary embodiments are described herein as having a multi-layer roll of reinforcement material wherein a length of adjacent layers differ in length, the layers can also differ by other properties (e.g., width, thickness, weight, composition, etc.). As another example, while the exemplary embodiments shown and described herein illustrate a fabric stack including three distinct layers, the general inventive concepts are not so limited and instead contemplate fabric stacks that can have more or fewer total layers. It is sought, therefore, to cover all such changes and modifications as fall within the spirit and scope of the general inventive concepts, as described and claimed herein, and any equivalents thereof.

1. A system for producing a structural component formed by molding a plurality of layers of a fiber reinforced material, the system comprising a roll of the fiber reinforced material, wherein the roll includes a plurality of layers of the fiber reinforced material, wherein a first layer of the fiber reinforced material on the roll is adjacent to a second layer of the fiber reinforced material on the roll, wherein a length of the first layer differs from a length of the second layer to form an offset, and wherein the offset corresponds to the desired positioning of the first layer relative to the second layer in a mold.

2. The system of claim 1, wherein the roll comprises 3 to 10 layers of the fiber reinforced material.

3. The system of claim 1, wherein the roll comprises at least 4 layers of the fiber reinforced material.

4. The system of claim 1, wherein the first layer is fixed to the second layer on the roll.

5. The system of claim 4, wherein the first layer is fixed to the second layer by at least one of an adhesive, stitching, and one or more removable clips.

6-7. (canceled)

8. The system of claim 1, wherein the structural component is a spar cap.

9. The system of claim 1, wherein the fiber reinforced material includes at least one of glass fibers and carbon fibers.

10. The system of claim 1, further comprising a resin for introducing into the mold.

11. A system for producing a structural component formed by molding a plurality of layers of a fiber reinforced material, the system comprising a roll of the fiber reinforced material, wherein the roll includes a plurality of layers of the fiber reinforced material, wherein the roll includes indicia of where to cut the fiber reinforced material to form a first length of the fiber reinforced material and a second length of the fiber reinforced material, wherein a first layer of the fiber reinforced material in the first length is adjacent to a second layer of the fiber reinforced material in the first length, wherein a third layer of the fiber reinforced material in the second length is adjacent to a fourth layer of the fiber reinforced material in the second length, wherein a length of the first layer differs from a length of the second layer to form a first offset, wherein a length of the third layer differs from a length of the fourth layer to form a second offset, wherein the first offset corresponds to the desired positioning of the first layer relative to the second layer in a mold, and wherein the second offset corresponds to the desired positioning of the third layer relative to the fourth layer in the mold.

12. The system of claim 11, wherein the length of the first layer differs from the length of the third layer.

13. The system of claim 11, wherein the length of the second layer differs from the length of the fourth layer.

14. The system of claim 11, wherein the roll comprises 3 to 10 layers of the fiber reinforced material.

15. The system of claim 11, wherein the roll comprises at least 4 layers of the fiber reinforced material.

16. The system of claim 11, wherein the first layer is fixed to the second layer on the roll.

17. The system of claim 16, wherein the first layer is fixed to the second layer by at least one of an adhesive, stitching, and one or more removable clips.

18-19. (canceled)

20. The system of claim 11, wherein the third layer is fixed to the fourth layer on the roll.

21. The system of claim 20, wherein the third layer is fixed to the fourth layer by at least one of an adhesive, stitching, and one or more removable clips.

22-23. (canceled)

24. The system of claim 11, wherein the structural component is a spar cap.

25. The system of claim 11, wherein the fiber reinforced material includes at least one of glass fibers and carbon fibers.

26. The system of claim 11, further comprising a resin for introducing into the mold.

27-45. (canceled)
